(19) United States
(12) Patent Application Publication
(10) Pub. No.: US 2022/0109360 A1
(43) Pub. Date: Apr. 7, 2022

(54) Toggle-type Magnetic Power Generation Device

(71) Applicant: Fujian Enstar Technology Co. LTD., Fuzhou, Fujian (CN)

(72) Inventors: Chunguang Li, Fuzhou, Fujian (CN); Qiang Yan, Fuzhou, Fujian (CN)

(21) Appl. No.: 17/273,293

(22) PCT Filed: Jan. 6, 2020
(86) PCT No.: PCT/CN2020/070440

§ 371 Date: Mar. 3, 2021

(30) Foreign Application Priority Data
Dec. 26, 2019 (CN) 201911367370.8

(51) Int. Cl. H02K 35/02; H02K 1/34

(52) U.S. Cl. CPC H02K 35/02; H02K 1/34

(57) ABSTRACT

The invention relates to the field of passive power generation devices, in particular to a toggle-type magnetic power generation device, which comprising a coil, a magnetic core, a coil bobbin and a coil support. A through groove allowing the magnetic core to penetrate through is formed in the coil bobbin. The coil is wound around the outer surface of a side wall of the through groove and corresponds to the magnetic core. An opening allowing part of the coil bobbin to be embedded therein is formed in the coil support. The opening is formed in the coil support and allows part of the coil bobbin to be embedded therein, so that the number of turns of the coil is increased under the precondition of maintaining the existing size, thus improving the power generation capacity and the stability of the electrical performance of the magnetic power generation device.

### TECHNICAL FIELD

The invention relates to the field of passive power generation devices, in particular to a toggle-type magnetic power generation device.

### DESCRIPTION OF RELATED ART

At present, there are many magnetic power generation devices, of which the most common ones are power generators. However, the magnetic power generation devices, represented by power generators, are large in size and are not suitable for environmental conditions with strict size limitations. When the magnetic power generation devices, represented by power generators, are used to convert mechanical energy into electric energy, the mechanical energy must be rotatable, which make the magnetic power generation devices, represented by power generators, inapplicable under some conditions. In addition, in some application scenarios where the size of the magnetic power generation device needs to be as small as possible, it is impossible to improve the power generation capacity due to the size limitation of the magnetic power generation devices on the present market, and the electrical performance of the magnetic power generation devices is instable.

### BRIEF SUMMARY OF THE INVENTION

The technical issue to be settled by the invention is to provide a toggle-type magnetic power generation device which can improve the power generation capacity under the precondition of maintaining the existing size, so that the stability of the electrical performance of the magnetic power generation device is improved to be suitable for application scenarios with strict size requirements.

The technical solution adopted by the invention to settle the aforesaid technical issue is as follows:

A toggle-type magnetic power generation device comprises a coil, a magnetic core, a coil bobbin and a coil support, wherein the coil bobbin is mounted on the coil support, a through groove allowing the magnetic core to penetrate through is formed in the coil bobbin, the magnetic core is arranged in the through groove, the coil is wound around the outer surface of a side wall of the through groove and corresponds to the magnetic core, and an opening allowing part of the coil bobbin to be embedded therein is formed in the coil support.

The invention has the following beneficial effects:

According to the toggle-type magnetic power generation device provided by the invention, the opening is formed in the coil support and allows part of the coil bobbin to be embedded therein, so that the number of turns of the coil is increased under the precondition of maintaining the existing size, thus improving the power generation capacity and the stability of the electrical performance of the magnetic power generation device; moreover; and the edge of the opening enables the coil bobbin to move only in the embedded direction, so that the assembly stability of the coil bobbin and the coil support is improved, and the cost is reduced.

### BRIEF DESCRIPTION OF THE SEVERAL VIEWS OF THE DRAWINGS

FIG. 1 is a structural diagram of a toggle-type magnetic power generation device of the invention;

FIG. 2 is a side view of an existing toggle-type magnetic power generation device;

FIG. 3 is a side view of the toggle-type magnetic power generation device of the invention;

### REFERENCE SIGNS

1, coil;

2, magnetic core;

3, coil bobbin; 31, through groove; 32, insert; 321, bump; 33, through hole;

4, coil support; 41, opening; 42, bar member; 43, fixed wall; 431, first mounting hole; 44, ring part; 441, second mounting hole;

5, solder pin.

### DETAILED DESCRIPTION OF THE INVENTION

The technical contents, purposes and effects of the invention will be explained in detail below in conjunction with implementations and accompanying drawings.

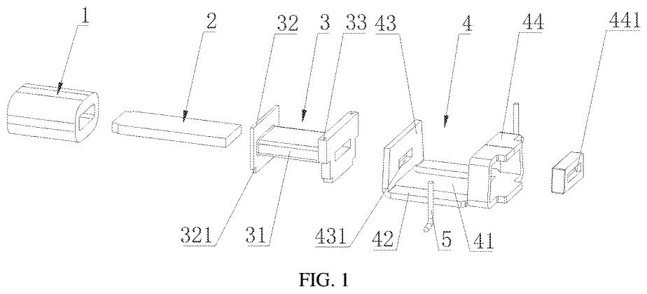

Referring to FIG. 1 and FIG. 3, the invention provides a toggle-type magnetic power generation device which comprises a coil, a magnetic core, a coil bobbin and a coil support, wherein the coil bobbin is mounted on the coil support, a through groove allowing the magnetic core to penetrate through is formed in the coil bobbin, the magnetic core is arranged in the through groove, the coil is wound around the outer surface of a side wall of the through groove and corresponds to the magnetic core, and an opening allowing part of the coil bobbin to be embedded therein is formed in the coil support.

From the above description, the toggle-type magnetic power generation device provided by the invention has the following beneficial effects: the opening is formed in the coil support and allows part of the coil bobbin to be embedded therein, so that the number of turns of the coil is increased under the precondition of maintaining the existing size, thus improving the power generation capacity and the stability of the electrical performance of the magnetic power generation device; moreover; and the edge of the opening enables the coil bobbin to move only in the embedded direction, so that the assembly stability of the coil bobbin and the coil support is improved, and the cost is reduced.

Furthermore, the coil support comprises a bar member, a fixed wall arranged at one end of the bar member, and a ring part arranged at the other end of the bar member, the opening is located in the bar member, the fixed wall and the ring part are located on the same size of the bar member, a first mounting hole is formed in the fixed wall, a second mounting hole is formed in the ring part, and two ends of the magnetic core penetrate into the first mounting hole and the second mounting hole, respectively.

From the above description, the magnetic core is fixed by means of the first mounting hole and the second mounting hole, and the first mounting hole and the second mounting hole are located on the same horizontal plane, so that the magnetic core and the bar member are in parallel after being assembled, and the coil wound around the outer side of the magnetic core can be uniformly embedded in the opening.

Furthermore, the thickness of an edge, corresponding to the opening, of the bar member is 1-3 mm.

From the above description, the thickness of the edge, corresponding to the opening, of the bar member is 1-3 mm, so that the overall thickness is effectively reduced under the precondition that magnetic circuit requirements are met.

Furthermore, the cross-section of the opening is rectangular.

From the above description, the opening of this structure is regular and easy to machine and allows part of the coil bobbin to be embedded therein easily.

Furthermore, two inserts are arranged on the coil bobbin and are located at two ends of the through groove, respectively, and bumps are arranged at the bottoms of the inserts and are matched with the opening.

From the above description, the coil bobbin is embedded in the opening through the bumps at the bottoms of the two inserts so that the overall thickness of the coil bobbin is reduced; moreover, the distance between the two bumps matches the size of the opening in the length direction of the magnetic core, that is to say, the coil bobbin will not move in the length direction and width direction of the magnetic core after being assembled, so that a good limiting effect is realized.

Furthermore, the magnetic power generation device further comprises a solder pin, through holes are formed in two opposite sides of the insert at an end, close to the ring part, of the coil bobbin, and the solder pin penetrates through the through holes.

Furthermore, the fixed wall is perpendicular to the bar member, and the magnetic core is parallel to the bar member.

Furthermore, the ring part is internally filled with a plastic part, and the second mounting hole is located at the center of the plastic part.

From the above description, the magnetic core indirectly contacts with the ring part through the plastic part rather than directly contacting with the ring part.

Furthermore, the coil support is made of metal.

From the above description, the ring part is made of metal, and the plastic part is insulative and can isolate the magnetic core from the ring part.

Referring to FIG. 1-FIG. 3, Embodiment 1 of the invention is as follows:

The invention provides a toggle-type magnetic power generation device which comprises a coil 1, a magnetic core 2, a coil bobbin 3 and a coil support 4, wherein the coil bobbin 3 is mounted on the coil support 4, a through groove 31 allowing the magnetic core 2 to penetrate through is formed in the coil bobbin 3, the magnetic core 2 is arranged in the through groove 31, the coil 1 is wound around the outer surface of a side wall of the through groove and corresponds to the magnetic core 2, and an opening 41 allowing part of the coil bobbin 3 to be embedded therein is formed in the coil support 4.

The coil support 4 comprises a bar member 42, a fixed wall 43 arranged at one end of the bar member, and a ring part 44 arranged at the other end of the bar member, the opening 41 is located in the bar member 42, the fixed wall 43 and the ring part 44 are located on the same side of the bar member 42, a first mounting hole 431 is formed in the fixed wall 43, a second mounting hole 441 is formed in the ring part 44, and two ends of the magnetic core 2 penetrate into the first mounting hole 431 and the second mounting hole 441, respectively. The magnetic core is fixed by means of the first mounting hole and the second mounting hole, and the first mounting hole and the second mounting hole are located on the same horizontal plane, so that the magnetic core and the bar member are in parallel after being assembled, and the coil wound around the outer side of the magnetic core can be uniformly embedded in the opening. Wherein, a columnar inset is arranged on an end face, close to the first mounting hole, of the magnetic core and is matched with the first mounting hole.

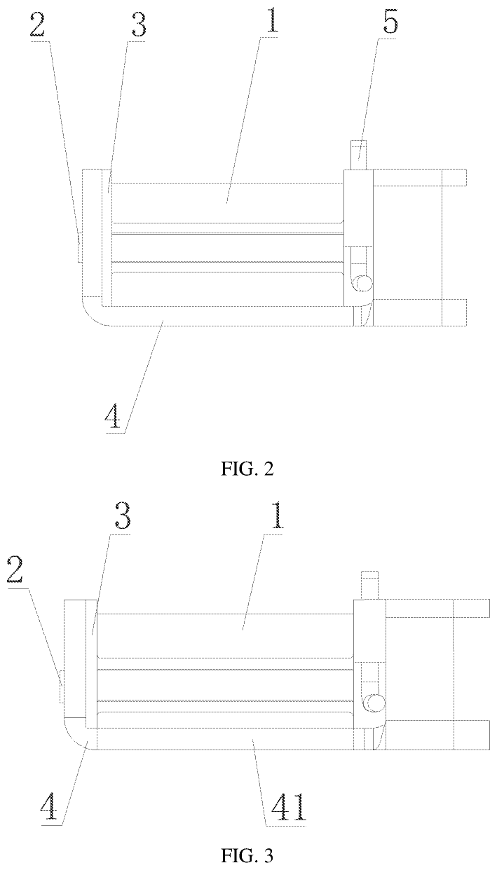

The thickness of an edge, corresponding to the opening, of the bar member 42 is 1-3 mm and is preferably 1 mm, so that under the precondition that magnetic circuit requirements are met, the overall thickness is effectively reduced. Wherein, it can be seen, by comparing FIG. 2 with FIG. 3, that the coil bobbin is partially embedded in FIG. 3, so that the number of turns of the coil can be increased to 1100. In this embodiment, the overall thickness can also be reduced by designing the specific dimension and shape of the opening, and the height of the fixed wall and the ring part can be reduced, accordingly. The height of the fixed wall 43 and the ring part 42 is 8.19 mm before improvement and is 7.19 mm after improvement, so the overall thickness is reduced.

The cross-section of the opening 41 is rectangular, and the specific dimension of the opening 41 is 13.59 mm*10.45 mm. The opening of this structure is regular and easy to machine and allows part of the coil bobbin to be embedded therein easily.

Two inserts 32 are arranged on the coil bobbin 3 and are located at two ends of the through groove 31, respectively. Bumps 321 are arranged at the bottoms of the inserts 32 and are matched with the opening 41. The coil bobbin is embedded in the opening through the bumps at the bottoms of the two inserts, so that the overall thickness of the coil bobbin is reduced; moreover, the distance between the two bumps matches the size of the opening in the length direction of the magnetic core, that is to say, the coil bobbin will not move in the length direction and width direction of the magnetic core after being assembled, so that a good limiting effect is realized.

The magnetic power generation device further comprises a solder pin 5, through holes 33 are formed in two opposite sides of the insert at an end, close to the ring part, of the coil bobbin 3, and the solder pin 5 penetrates through the through holes 33.

The fixed wall is perpendicular to the bar member, and the magnetic core is parallel to the bar member.

The ring part is internally filled with a plastic part, and the second mounting hole is located at the center of the plastic part. The magnetic core indirectly contacts with the ring part through the plastic part rather than directly contacting with the ring part. The coil support is made of metal. The ring part is made of metal, and the plastic part is insulative and can isolate the magnetic core from the ring part.

It should be noted that electromagnetic induction refers to a phenomenon that induced electromotive force is generated due to magnetic flux variation. The basic formula of the law of electromagnetic induction is: e=−n(dΦ)/(dt), wherein n is the number of turns of the coil, ΔΦ is the magnetic flux variation, Δt is the variation time, and e is the induced electromotive force generated.

Although the toggling speed of a trigger button has a minimal impact on the induced electromotive force, coils with different numbers of turns are tested under the condition of constant and consistent toggling speeds in this solution, and test results are shown in Table 1:

TABLE 1

| Number of | Press power | Rebound power |
|---|---|---|
| turns (n) | generation (e) | generation (el) |
| 800 | 119 uJ | 156 uJ |
| 900 | 185 uJ | 210 uJ |
| 1000 | 226 uJ | 262 uJ |
| 1100 | 266 uJ | 380 uJ |
| 1200 | 229 uJ | 282 uJ |

As can be seen from Table 1, when the number of turns reaches 1100, the press power generation and the rebound power generation are optimized. However, a traditional toggle-type magnetic power generation device can only be equipped with a coil with 900-1000 turns due to their size limitation. In the invention, the opening is formed in the coil support and allows part of the coil bobbin to be embedded therein, so that the toggle-type magnetic power generation device of the invention can be equipped with a coil with 1100 turns under the precondition of maintaining the original overall size, thus improving the power generation capacity; and the electrical performance of the toggle-type magnetic power generation device of the invention is more stable.

To sum up, according to the toggle-type magnetic power generation device, the opening is formed in the coil support and allows part of the coil bobbin to be embedded therein, so that the number of turns of the coil is increased under the precondition of maintaining the existing size, thus improving the power generation capacity and the stability of the electrical performance of the magnetic power generation device; moreover; and the edge of the opening enables the coil bobbin to move only in the embedded direction, so that the assembly stability of the coil bobbin and the coil support is improved, and the cost is reduced.

The above description is merely used to explain the embodiments of the invention, and is not intended to limit the patent scope of the invention. All equivalent transformations made according to the contents in the specification and the drawings, or direct or indirect applications to relating technical fields should also fall within the patent protection scope of the invention.

What is claimed is:

1. A toggle-type magnetic power generation device, comprising a coil, a magnetic core, a coil bobbin and a coil support, wherein the coil bobbin is mounted on the coil support, a through groove allowing the magnetic core to penetrate through is formed in the coil bobbin, the magnetic core is arranged in the through groove, the coil is wound around an outer surface of a side wall of the through groove and corresponds to the magnetic core, and an opening allowing part of the coil bobbin to be embedded therein is formed in the coil support.

2. The toggle-type magnetic power generation device according to claim 1, wherein the coil support comprises a bar member, a fixed wall arranged at one end of the bar member, and a ring part arranged at another end of the bar member, the opening is located in the bar member, the fixed wall and the ring part are located on a same size of the bar member, a first mounting hole is formed in the fixed wall, a second mounting hole is formed in the ring part, and two ends of the magnetic core penetrate into the first mounting hole and the second mounting hole, respectively.

3. The toggle-type magnetic power generation device according to claim 2, wherein a thickness of an edge, corresponding to the opening, of the bar member is 1-3 mm.

4. The toggle-type magnetic power generation device according to claim 2, wherein a cross-section of the opening is rectangular.

5. The toggle-type magnetic power generation device according to claim 2, wherein two inserts are arranged on the coil bobbin and are located at two ends of the through grooves, respectively, and bumps are arranged at bottoms of the inserts and are matched with the opening.

6. The toggle-type magnetic power generation device according to claim 2, further comprising a solder pin, wherein through holes are formed in two opposite sides of the insert at an end, close to the ring part, of the coil bobbin, and the solder pin penetrates through the through holes.

7. The toggle-type magnetic power generation device according to claim 2, wherein the fixed wall is perpendicular to the bar member, and the magnetic core is parallel to the bar member.

8. The toggle-type magnetic power generation device according to claim 2, wherein the ring part is internally filled with a plastic part, and the second mounting hole is located at a center of the plastic part.

9. The toggle-type magnetic power generation device according to claim 1, wherein the coil support is made of metal.
